(19) United States
(12) Patent Application Publication
(10) Pub. No.: US 2014/0244960 A1
(43) Pub. Date: Aug. 28, 2014

(54) COMPUTING DEVICE, MEMORY MANAGEMENT METHOD, AND PROGRAM

(71) Applicant: KABUSHIKI KAISHA TOSHIBA, Tokyo (JP)

(72) Inventors: Kotaro ISE, Kawasaki-shi (JP); Masataka GOTO, Yokohama-shi (JP)

(73) Assignee: KABUSHIKI KAISHA TOSHIBA, Tokyo (JP)

(21) Appl. No.: 14/190,334

(22) Filed: Feb. 26, 2014

(30) Foreign Application Priority Data
Feb. 28, 2013 (JP) 2013-039079

(51) Int. Cl. G06F 3/06

(52) U.S. Cl. CPC G06F 3/0647; G06F 3/0604; G06F 3/0673
USPC 711/165

(57) ABSTRACT

According to one embodiment, there is provided a computing device managing a first memory region and a second memory region, a power consumption to hold data stored in the second memory region being smaller than that of the first memory region, including: a data manager and a data processor. The data manager manages a referring number, which is a number of processes referring to first data existing in either one of the first memory region or the second memory region. The data processor moves the first data to the second memory region when the first data exists in the first memory region and the referring number to the first data satisfies a first condition.

### CROSS REFERENCE TO RELATED APPLICATIONS

This application is based upon and claims the benefit of priority from the prior Japanese Patent Application No. 2013-039079 filed on Feb. 28, 2013, the entire contents of which are incorporated herein by reference.

### FIELD

Embodiments described herein relates to a computing device, a memory management method, and a program.

### BACKGROUND

In recent years, a computing device represented by a personal computer has become significantly widespread and a computing device technology is used to perform an information processing for a cellular phone, copier, home router and the like. The computing device technology characteristically includes a memory device such as a DRAM, and achieves the information processing by processing data stored in the memory and storing the resultant processed data in the memory. In other words, these devices are characterized by inclusion of a memory region for carrying out one or both of reading and writing of the data.

In recent years, demand for reducing power consumption of the computing device has increased. Motivation behind this demand includes power cost reduction and malfunction prevention of the computing device due to heat generation. Moreover, it also includes extending operating time in the case of a battery-driven device. There are other various motivations. This power consumption reduction demand toward the computing device leads to a power consumption reduction demand toward the memory device included in the computing device.

### BRIEF DESCRIPTION OF THE DRAWINGS

FIG. 1 is a diagram illustrating an exemplary hardware configuration of a computing device according to an embodiment.

FIG. 2 is a diagram illustrating a state where a mapped file is shared with a plurality of processes.

FIG. 3 is a diagram illustrating an exemplary configuration of a memory module.

FIG. 4 is a diagram illustrating a relationship between addresses and segments of the memory module.

FIG. 5 is a diagram for explaining an address translation operation from a logical address to a physical address.

FIG. 6 is a diagram illustrating an exemplary segment information management table.

FIG. 7 is a diagram illustrating an exemplary usage state of a physical memory.

FIG. 8 is a diagram illustrating another exemplary configuration of the memory module.

FIG. 9 is a diagram illustrating still another exemplary configuration of the memory module.

FIG. 10 is a diagram illustrating a management structure of system cache data in an OS.

FIG. 11 shows an operation flowchart according to the embodiment.

FIG. 12 is a block diagram of a processing unit concerning memory power control of the computing device according to the embodiment.

FIG. 13 is a block diagram of a processing unit concerning memory data management control of the computing device according to the embodiment.

### DETAILED DESCRIPTION

According to one embodiment, there is provided a computing device managing a first memory region and a second memory region, a power consumption to hold data stored in the second memory region being smaller than that of the first memory region, including: a data manager and a data processor.

The data manager manages a referring number, which is a number of processes referring to first data existing in either one of the first memory region or the second memory region.

The data processor moves the first data to the second memory region when the first data exists in the first memory region and the referring number to the first data satisfies a first condition.

Hereinafter, embodiments will be described with reference to the accompanying drawings.

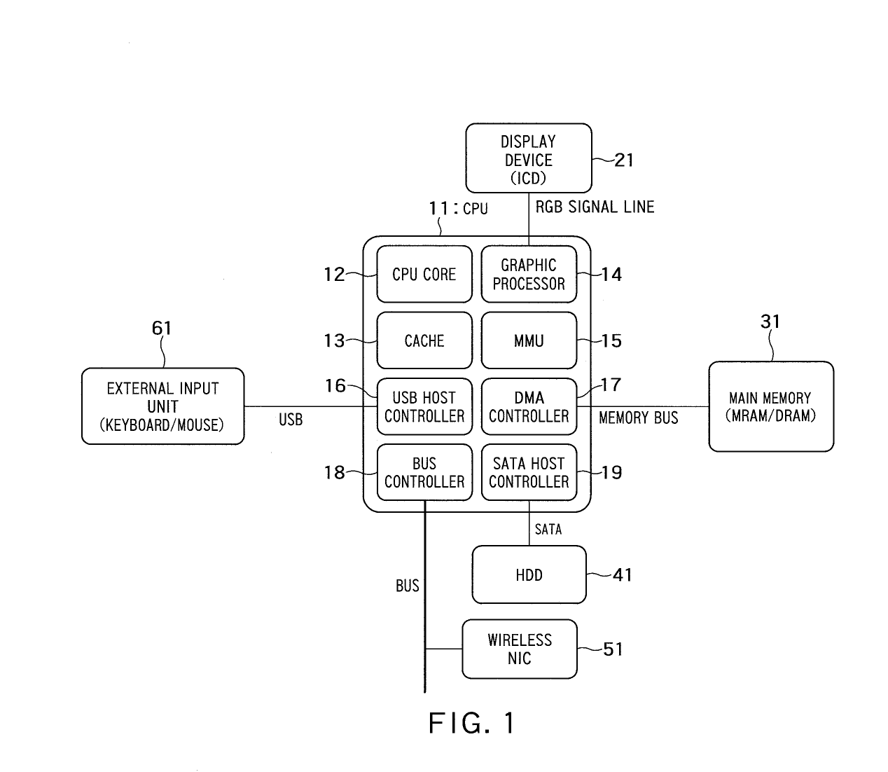

FIG. 1 shows an exemplary hardware configuration of a computing device according to an embodiment.

The computing device includes a CPU 11, and a display device (e.g., LCD (liquid crystal display)) 21, main memory 31, HDD (hard disk drive) 41, wireless NIC 51, and external input unit (keyboard, mouse and the like) 61 which are connected to the CPU 11. The CPU 11 includes one or more CPU cores 12, cache area (hereafter, referred to as cache) 13, graphic processor 14, MMU (memory management unit) 15, USB host controller 16, DMA (direct memory access) controller 17, bus controller 18, and SATA (serial advanced technology attachment) host controller 19.

The CPU core 12 performs arithmetic operations on the basis of an execution instruction.

The graphic processor 14 generates an RGB signal in accordance with a drawing instruction from the CPU core 12 to output this signal to the display device 21.

The cache 13 is a storage device provided in order to improve a delay when the CPU core 12 accesses the main memory 31. The CPU core 12, upon reading content of the memory, first confirms content of the cache 13. If the content of the memory is not held in the cache 13, a value is read from the main memory 31 and the content thereof is stored in the cache 13. If the content of the memory is present in the cache 13, a value in the cache 13 is read. The CPU core 12 first rewrites the content held in the cache 13 in order to write the data in the memory 31. The rewritten content is written in the main memory 31 in accordance with a method called write back or write through, for example. A storage system used for the cache 13 may be variously composed of an SRAM, DRAM and the like. The cache 13 preferably has access delay less than the main memory.

The MMU 15 is a device carrying out translation between a physical address used upon access to the main memory 31 and a virtual address used by an OS (operating system) operating on the CPU core 12 (or, logical address, and the virtual address and the logical address are used with being not distinguished from each other herein). The virtual address is used as an input and the physical address corresponding thereto is output. All information of the translation between the virtual address and the physical address may be held in a memory inside the MMU 15. Alternatively, a part of a translation table may be held in the MMU 15, and other parts may be held outside such as in the main memory 31. A way of holding only the part includes, for example, a method in which the MMU 15 has a high-speed memory called a TLB (translation lookaside buffer), only translation data not held in the TLB is acquired by referring to the main memory 31, and the acquired translation data is written in the TLB.

The USB host controller 16 performs information transmission and reception to and from a USB device on the basis of a USB (universal serial bus) standard.

The DMA controller 17 performs a processing of data transmission and reception to and from the main memory 31, devices on the bus (wireless NIC and the like), and SATA device (HDD and the like). The DMA controller 17 negotiates with the CPU core 12 to acquire bus controls. The DMA controller 17 having the acquired bus controls receives data from a device on the bus and writes the received data in the main memory 31. Alternatively, the DMA controller 17 reads data in the main memory 31 and transmits the data to the device on the bus.

The bus controller 18 performs data transmission and reception to and from the device on the bus complying with a bus standard, for example, PCI-Express and the like.

The SATA host controller 19 performs data transmission and reception to and from the device (HDD) through a SATA cable complying with a SATA (serial advanced technology attachment) standard.

The display device 21 displays a signal input via the RGB signal in a form readable by a person.

The main memory 31 is, for example, a DRAM (dynamic random access memory) and connected with the CPU 11 via an interface (memory bus) called a DDR3, for example (the CPU 11 has a memory controller not shown in the figure). This main memory 31 is further preferably constructed by a nonvolatile memory technology such as an MRAM (magneto-resistive random access memory), FeRAM (ferroelectric random access memory), PRAM (phase change random access memory), and ReRAM (resistive random access memory).

When the physical address output from the MMU 15 is passed to the memory controller, the memory controller translates this into a memory address to allow a value to be accessed which is held in a region in the main memory corresponding to the memory address.

The main memory 31, upon receiving a read instruction from the CPU 11, reads and outputs to the CPU 11 a value held in a region corresponding to address information given together with the read instruction. Further, upon receiving a write instruction from the CPU 11, receives the address information and the value together with the write instruction to write the received value into a region corresponding to the address information. Various interfaces such as a LPDDR3 and WideIO are used in addition to the DDR3 for a connection interface between the main memory 31 and the CPU 11.

Here, in the embodiment there exist a hot memory region (first memory region) and a cold memory region (second memory region) as the memory regions. The hot memory region is larger in power consumption required for holding the data and smaller in the power consumption or access time required for data access (read/write) than the cold memory region. For example, it can be considered that in the DRAM, an Idle state and an Active state (that is, a state in which a Row address or Col address is input and read/write is enabled) are hot states and other states including a Self Refreshing state and a Power Down state are cold states. The hot memory region and cold memory region may be fixed in advance or switchable to each other.

In case where memories having different characteristics from each other, such as the DRAM and MRAM, coexist as the main memory, it can be considered that a memory which is large in the power consumption required for holding the data but small in the power consumption or time required for data access is the hot memory region, and any memories other than that is a cold memory region. Hereinafter, the hot memory region may be referred to as an active region and the cold memory region may be referred to as a sleep region.

A HDD 41 is a device for storing magnetic media digital information, like MK1059GSM from TOSHIBA CORPORATION, for example, and connected with the CPU 11 the via a SATA interface. A semiconductor storage device (NAND flash) called an SSD may be used in place of the HDD. Various systems may be used for storing the digital information, while a larger capacity than the main memory 31 is preferable. For the connection between the HDD 41 and the CPU 11, various interfaces such as an SCSI, Fiber Channel, PCI-Express or the like may be used other than the SATA.

The wireless NIC (network interface card) 51 transmits and receives a communication packet to and from a network complying with the IEEE 802.11 standard, for example. The standard to be used is not limited to the IEEE802.11, and may be an interface for cellular communication called a LTE (long term evolution) or a wired interface called a 100M Ethernet.

The external input unit 61 is means for inputting operation by a human and may be a keyboard, mouse, and touch panel on the display device, for example. Moreover, a temperature sensor may be also used and the input information is not limited to that input by a human. In the embodiment, an external input is transmitted to the CPU 11 complying with the USB standard, but the external input unit 61 may be connected using other standards (e.g., IEEE1394, RS-232C, and HDMI) than the USB.

In the embodiment, the configuration in FIG. 1 is used as the hardware configuration, but the configuration may be such that any one or more of the graphic processor, MMU, USB host controller, DMA controller, bus controller, SATA host controller are present outside the CPU 11. Further, various modifications may be considered where a part function of the wireless NIC is included in the CPU 11.

### (Explanation of System Cache)

When a process or OS refers to, for example, a file on the hard disk, in a procedure performed, the file is stored from the hard disk to the memory, and thereafter, file data on the memory is accessed. Generally, since access to the hard disk is slower than access to the memory, even if the file is no longer used by the process or kernel, the file data is continued to be held on the memory. Such data that is not used but held is referred to as “system cache data”. A file storage place here may be various storage places including a CD-ROM, SSD (solid state drive), NAS (network attached storage) and the like other than hard disk. As for the system cache data, besides the file data, data held on the memory which is even the data such as HTML data acquired via the network is referred to as the system cache data.

In order that the OS determines whether or not the file is being used, the process, upon using the file, calls a system call for declaring start of using file such as fopen( ) or mmap( ). In a case of ending of using the file, a system call for declaring end of using file such as fclose( ) or unmap( ) is called.

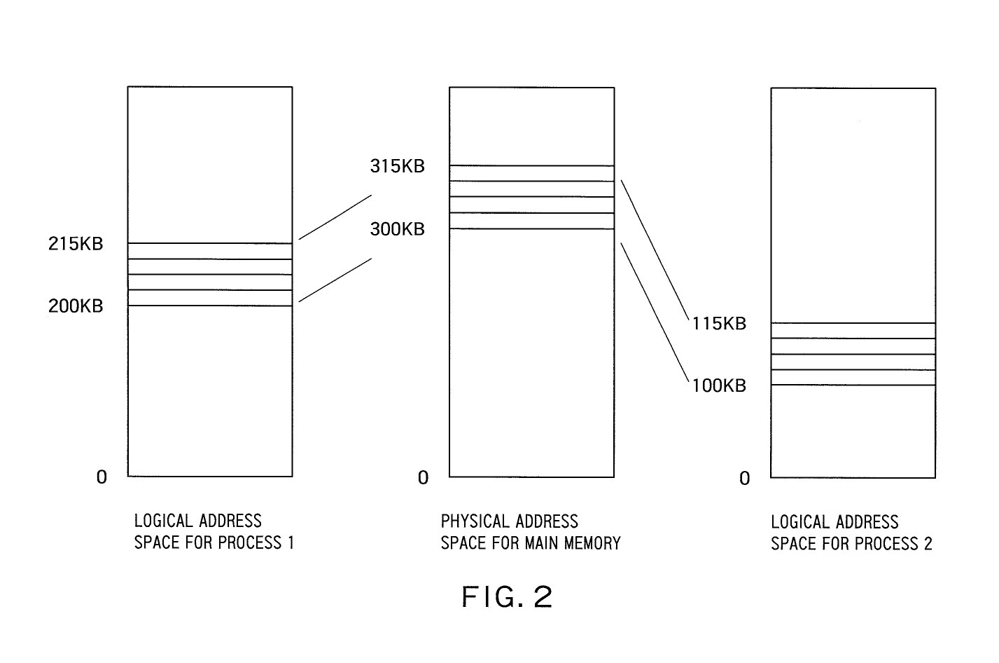

When the process refers to the file, the OS copies the file data from the hard disk onto the main memory to be a mapped file, of which memory address is made to correspond to a virtual space for the process. FIG. 2 shows a state where the mapped file is assigned to a region of a physical memory address 300 KB to 315 KB, which is assigned to a logical address 200 KB to 215 KB for a process 1 and a logical address 100 KB to 115 KB for a process 2. In this way, the mapped file may be shared with a plurality of processes. Moreover, FIG. 2 shows a state where four pages are assigned, but in a case of an on-demand paging system, physical pages are not assigned until the process actually refers to the memory.

In FIG. 2, when both the process 1 and the process 2 end referring to the file, the physical memory region assigned to the file can be freed. Nevertheless, if the physical memory has a free space, the physical memory region assigned to the file may be remained not free. In this case, when referring to the file occurs again, the physical addresses of the physical memory region can made to correspond to logical addresses of the process performing the reference. This allows the access time to the file to be shortened. The data not being used but held on the physical memory like this is referred to as the system cache data as described above.

Here, examples of the system cache data may include, as in the case of reading the file data into the physical memory page, page cache data for managing in units of page, and buffer cache data for holding a clump of data on a block device (e.g., a block of a file system).

In the computing device which manages the memory region including the hot memory region and cold memory region having the characteristics as described above, the system cache held in the hot memory region moves to the cold memory region when the number of the processes referring to the system cache (referring number) is satisfies a first condition. The first condition includes cases where the system cache is not already used, that is, the number (referring number) of the processes referring to the system cache is zero. More generally, a case is included where the referring number falls from a value larger than a threshold down to that equal to or less than the threshold. Alternatively, a case is included where no access is carried out during a predefined time period T_hot from when the referring number becomes zero. In such cases, the system cache is moved to the cold memory region such that the free space in the hot memory region can be increased to allow data, which is newly accessed after the movement, to be arranged in the hot memory region. Since the hot memory region is small in the power consumption required for data access as described above, arrangement of the data to be accessed in the hot region exerts an effect of the power consumption reduction.

Here, T_hot is not fixed value and may be also set in a manner that the smaller the free space of the hot memory region, the smaller the value thereof is. Further, in a case where the system cache data becomes dirty data due to a Write access by the process, that is, has a value different from the corresponding data in the hard disk, T_hot is preferably set to a value smaller compared with clean data. In addition, in the case where the system cache data is dirty, movement may be carried out from the hot memory region not to the cold memory region but to the hard disk.

The system cache held in the cold memory region may be moved from the cold memory region to the hard disk, when a second condition is satisfied. For example, in the case where no access is carried out during the predefined time period T_cold from when the referring number for the system cache becomes zero. This makes it possible to increase the free space in the cold memory region and hold the data small in an access frequency in the cold memory region. This exerts an effect of preventing memory shortage from occurring. Here, T_cold is not fixed value and may be also set in a manner the smaller the free space of the cold memory region, the smaller the value thereof is. Further, in a case where the system cache data becomes dirty data due to a Write access by the process, that is, has a value different from the corresponding data in the hard disk, T_hot is preferably set to a value smaller compared with clean data.

### (HW Configuration of Memory Module)

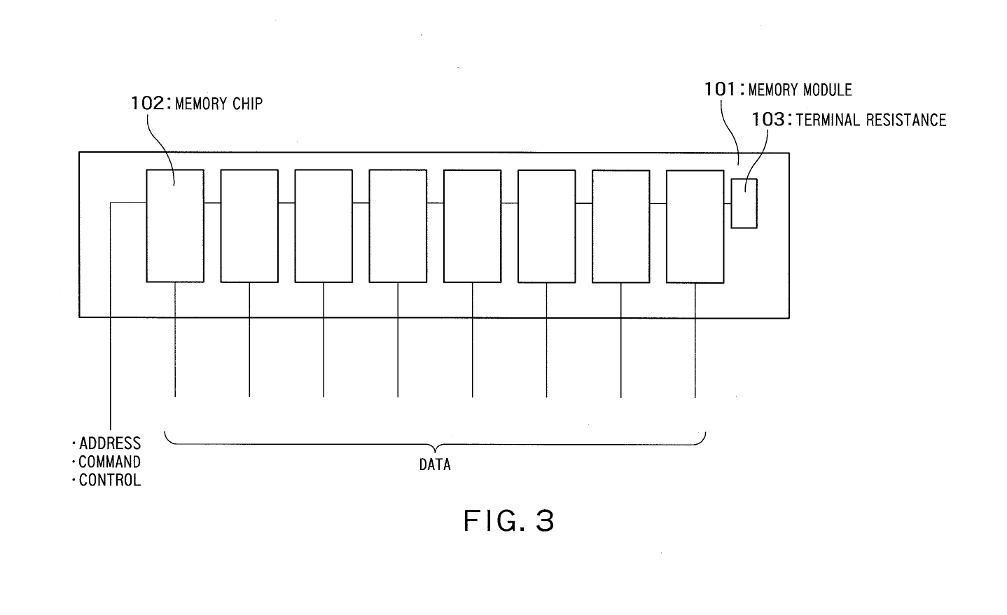

FIG. 3 shows an exemplary configuration of a memory module used for the main memory. A memory module 101 has eight memory chips (LSI) 102 on a board. The memory module 101 has a signal line for transmitting and receiving an address, command, and control signal to send the address, command, and control signal via the relevant signal line to each of the memory chips 102. The command includes Readcommand and Writecommand as below as well as PowerStateChangecommand for changing a power state of a memory segment (partial region). The control signal includes a clock signal, read/write timing signal and the like. Moreover, the memory module 101 has a signal line for transmitting and receiving the data to transmit and receive the data via the relevant signal line to and from each memory chip.

| command | Meaning |
|---|---|
| Read | Transmit data held in region designated by |
| | address to signal line |
| Write | Store data given by data signal line in region |
| | designated by address |
| PowerStateChange | Set segment corresponding to segment |
| | number given by command signal line into |
| | designated power state |

Here, the power state includes two states of active and sleep. An active segment can read/write the data. A sleep segment continues to hold the stored data but cannot read/write. The power consumed in the segment is larger at the active state than the sleep state.

In the DRAM, the sleep state can be attained by, for example, selecting the segment to be made in a self-refresh mode. The self-refresh mode is a state where a refresh operation (an operation that content in the memory cell is read out and written again in that cell, since the information held in a memory cell is lost with time in the DRAM) is performed inside the segment of the memory module or memory chip. A refresh duration can be extended to reduce the power consumption. Further, the lower the temperature is, the longer an information held time for the memory cell of the DRAM generally is. For this reason, it is preferable in this self-refresh operation to extend the refresh duration as the temperature decreases. Moreover, since the information held time varies in the memory cell, the variation is preferably considered to set the refresh duration longer as much as possible.

On the other hand, a nonvolatile memory such as a MRAM does not require the power for holding the information. For this reason, the sleep state can be attained by selecting the segment, and stopping feeding the power to a signal for reading or writing the memory cell thereof, or lowering a voltage therefor. Further, preferably performed are stop of feeding the power, lowering the voltage, and stop of the clock with respect to other circuits such as a PLL (phase-locked loop), column decoder, row decoder, sense amplifier circuit and the like.

The memory module 101 is coupled with the CPU 11 via two kinds of signal lines described above. The CPU 11 can be connected with a plurality of memory modules. For example, the CPU 11 can be connected with two memory modules per one channel. In this case, if the CPU 11 has three channels, six memory modules in total can be connected.

The memory region of each memory chip 102 is divided into eight segments. Each memory chip 102 can change the power state in units of segments. When the power state is designated to, for example, a segment 1 from outside the memory module 101, the power states for the segments 1 of all the memory chips 102 are placed in a designated state. Note that this configuration is an example, and a configuration may be used that the segments 1 of all the memory chips 102 are respectively dealt with as a distinct segment to separately perform the power state control.

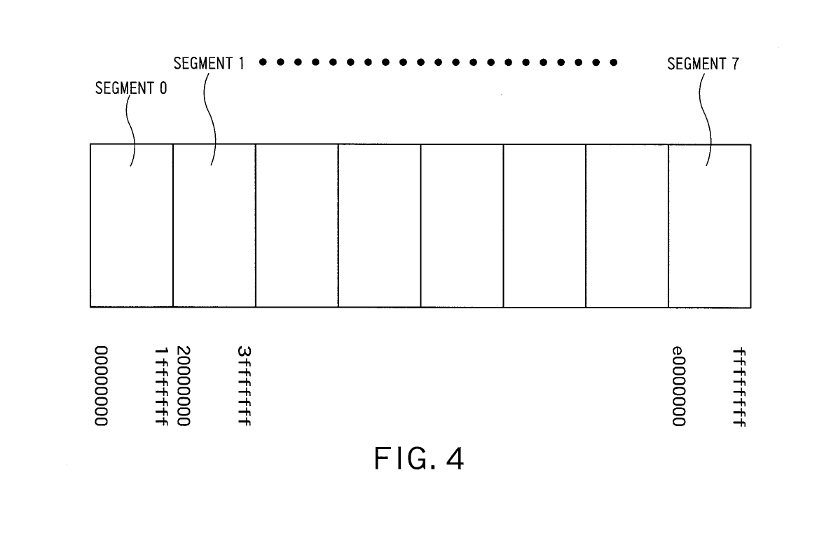

FIG. 4 shows a relationship between the physical addresses and segments of the memory module. Assuming that the memory module 101 has eight segments, that is, each memory chip 102 is divided into eight segments. The figure shows that a region of addresses from 0000000 to 1fffffff belongs to a segment 0, and a region of addresses from 20000000 to 3fffffff belongs to the segment 1.

In this example, each segment is configured to have the same size, but each segment may be configured to have a size of an arbitrary value. For example, it may be configured that the segment 0 has 1/128 of a memory capacity, the segment 1 has 1/128, a segment 2 has 1/64, a segment 3 has 1/32, a segment 4 has 1/16, a segment 5 has 1/8, a segment 6 has 1/4, and a segment 7 has 1/2.

In addition, FIG. 4 explains the example in which eight segments are included, but the number of the segments in not limited to eight. In general, the larger the segment number is, the higher the power consumption reduction effect can be expected, and at the same time a circuit scale for achieving the segment becomes larger. The segment number increase may lead to increase in a mounting cost of the circuit or in the power consumption.

If the computing device has four memory modules and each memory module has eight segments, the computing device has 32 segments in total. Of course, each memory module in the computing device may have the different number of segments.

### (Outline of Operation Principle)

When the computing device is powered on, a program called a BIOS is read into the main memory 31 and executed in the CPU core 12. The BIOS checks the hardware configuration of the computing device, initializes each device (HDD or wireless NIC), and reads the OS stored in the HDD 41 into the memory 31. After the OS is read into the memory 31, the BIOS passes the control to the OS (jumps to a predetermined instruction of the OS). The OS carries out a start-up processing to perform a predefined program. Alternatively, the program is started up in accordance with an input of the external input unit.

The OS accesses to the main memory in accordance with a memory allocation request from an application, memory deallocation request, read/write request to the allocated memory. At this time, the access frequency is measured for each segment. If the access frequency for the segment (calculation method is described later) is larger than a predefined threshold, the power state of the segment is set to active, and If not, the power state is set to sleep. If the read/write occurs with respect to a region of the segment set to sleep, the OS sets the segment to active and returns to sleep after completing the read/write. In this way, the segment small in the access frequency is set to the sleep state to allow the power consumption of the main memory to be reduced.

Here, the example is shown in which in reading/writing to the segment in the sleep state, the OS sets the power state thereof to active and returns to sleep after reading/writing. However, the changing the power state may be carried out by, in place of the OS, the memory controller, or the memory chip on the memory module 101. Alternatively, a control circuit (not shown) on the memory module 101 may carry out.

Further, if the memory controller holds a number of unprocessed memory access requests, accesses to a certain sleep segment are preferably processed collectively as possible. In other words, the sleep segment is set to the active state, a plurality of held access requests to the segment are processed collectively, and then, the segment is returned to the sleep state. This allows the changing number of the power state of the segment to be reduced, improving processing performance.

Here, a threshold λ′ for determining whether the power state of the segment is set to active or sleep may be decided depending on the characteristic of the memory module. For example, given that

Pₐ: power required for maintaining active state

Pₛ: power required for maintaining sleep state

Pₛₐ: power required for transiting from sleep state to active state

Pₐₛ: power required for transiting from active state to sleep state,

a formula below can find the threshold.

$${λ}^{′} = \frac{( {P}_{a} - {P}_{s} )}{{P}_{sa} + {P}_{as}} \qquad Math . 1$$

This finds how many times the power for accessing to the segment in the sleep state (power for transiting the power state to active and sleep) a power gain due to being made sleep (difference between the power possessed at active and the power possessed at sleep) corresponds to.

The access frequency is compared with the threshold λ′ for each segment, and if the access frequency is larger, the active state is set, and if not, the sleep state is set. In a case where a memory access delay is desired to be reduced rather than the power consumption, a threshold compared with the access frequency is preferably set smaller than λ′.

In addition, the thresholds different from segment to segment may be also used. For example, if the size of the segment is different, the threshold is set lager for the larger segment such that the larger segment is likely to be set to the sleep state. This can increase the power consumption reduction effect.

In a case where CPU load causes the CPU clock frequency to dynamically vary, it is preferable to set a smaller threshold as the CPU clock frequency increases. This is because the memory access frequency is known as an empirical rule to become larger in proportion to the CPU clock frequency.

In addition, if there is no problem even with large processing delay, the threshold λ′ is preferably set larger. For example, included are a case where a mouse input or keyboard input from a user does not occur for a certain period of time, and a case caused thereby where display on the display device is stopped. This makes many segments into the sleep state and allows the power consumption to be reduced.

Moreover, this threshold may be also varied depending on a degree of requirement for the power consumption reduction. For example, the power consumption can be reduced by increasing the threshold for a battery having smaller power. Of course, the user may be prompted to select a menu of “high power”, “normal”, “long power” and the like by a GUI such that the user adjusts the threshold.

Here, the access frequency measurement is carried out as below, for example.

Given that an access number to a segment i is Sᵢ(T,2T) from a time T to 2T. If the access frequency from the time T to 2T is Fᵢ(T,2T), the access frequency can be calculated using a formula as below. Here, “a” is a constant equal to or more than 0 and equal to or less than 1.

$${F}_{i} ( 0 , T ) = \frac{{S}_{i} ( 0 , T )}{T} \\ {F}_{i} ( nT , ( n \vert 1 ) T ) = a \cdot {F}_{i} ( ( \begin{matrix}n & 1\end{matrix} ) T , T ) \vert \begin{matrix}( 1 - a ) {S}_{i} ( n , ( n + 1 ) T ) \\ T\end{matrix} \qquad Math . 2$$

Fᵢ(nT,(n+1)T) is found at a time interval T, which is compared with the threshold, and thereby, the power state (active or sleep) for the segment i in the next time zone (n+2)T is decided.

Here, as for the system cache data, as described above, the system cache data present in the region in the active state (that is, hot memory region) is moved to the region in the sleep state (that is, cold memory region) if the time T_hot or more lapses after the referring number by the process becomes zero. Moreover, the system cache present in the region in the sleep state (that is, cold memory region) is written back to the hard disk if the time T_hot or more lapses after the referring number by the process becomes zero. T_cold is a value equal to or more than T_hot. In this way, the system cache not being accessed is moved to the cold memory region such that held power in the system cache is reduced and the power consumption can be expected to be reduced as a whole.

Here, it is also possible that the segment for system cache is defined in advance and set to the sleep state (that is, cold memory region), and the segment is not stored with data other than the system cache. This can prevent a region for holding system cache from becoming insufficient. Note that if the free space in the segment is large, modification may be also made such that data other than the system cache can be stored.

(Decision Method of Power State Depending on Information Other than Access Frequency)

In the above example, the access frequency Fᵢ( ) is used to decide the power state of the segment. This can be said that the access frequency in the future is predicted using the access frequency Fᵢ( ) in the past such that the power state of the segment (active or sleep) is decided in a manner that the power consumption in the future is the smallest. For this reason, a method for predicting the access frequency in the future can be applied similarly.

As another example, the power state of the segment can be decided by reference to task scheduling information of the OS. The task scheduling information is an algorism for deciding in a multitask OS the order of assigning to the CPU with respect to a plurality of tasks. With respect to the task assigned to the CPU, a processing by the CPU is performed only during a predefined CPU time. After that, a task next scheduled is assigned to the CPU. A task performing order can be predicted by referring to the task scheduling information (e.g., schedule cue). For this reason, tasks not assigned to the CPU in a predefined time window are listed to check the memory that the tasks use. The sleep can be decided for the power state of each of the segments in which memory usage used by the task not assigned to the CPU in the window is larger than a predetermined usage. The segment in which there is no usage by the task assigned to the CPU in the window may be set to sleep without any preconditions.

### (Detailed Operation of OS)

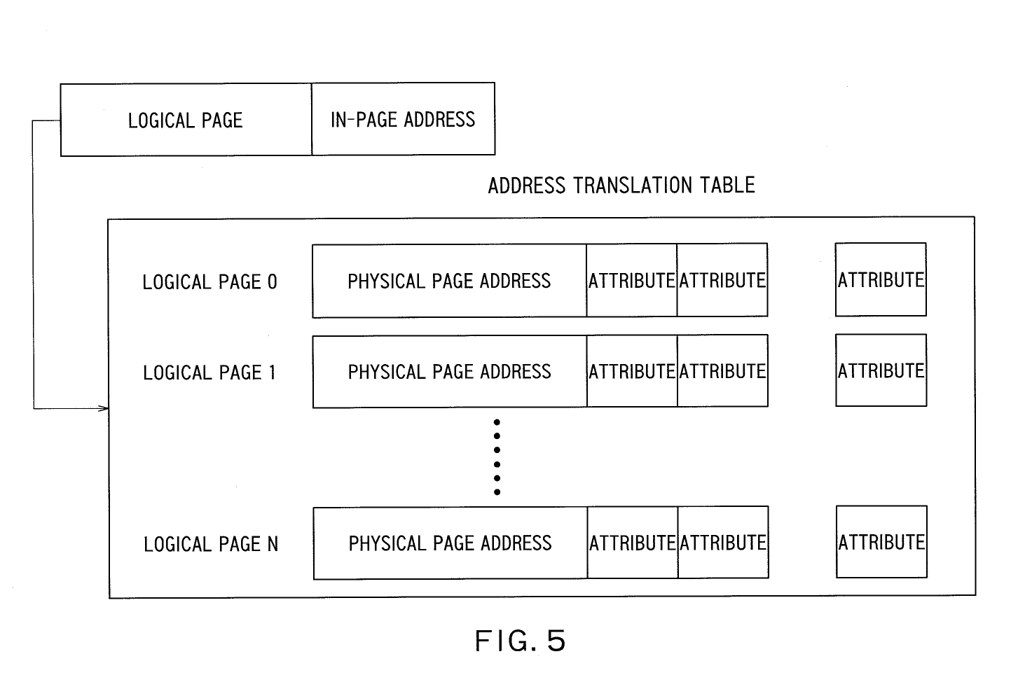

FIG. 5 simulatively shows an address translation operation from the logical address to the physical address.

The MMU 15 has an address translation table. The address translation table is used to allow searching for a corresponding entry from a logical page number. Here, an explanation will be given assuming that an address width is 32 bits and a page size is 4 KB as an example. The CPU uses upper 22 bits of 32 bits logical address as the logical page number and used lower 10 bits as an inner page address. The address translation table is searched for according to the logical page number decided from the logical address to obtain the corresponding entry. A physical page address of the entry is combined with the inner page address to get the physical address. Here, the combination means that the inner page address is combined to a lower bit side of a physical page number 22 bits.

The searched entry holds various attributes concerning the physical page. As examples of the attributes, availability of cache, access information (availability of writing), reference information (referred or not), correction information (corrected or not), presence information (present or not on the physical memory) can be listed.

Here, the case is shown where the MMU 15 has one address translation table. Otherwise, a plurality of address translation tables having a hierarchy organization called a multi-level page table may be included. Using a multi-page table allows a table size managed by the MMU 15 to be reduced. An important thing is that the corresponding physical address can be obtained from the logical address.

Additionally, the address translation table the MMU 15 has is held on the main memory 31 by the OS, and the address translation table corresponding to a process operating on the CPU core 12 (or OS) can be loaded to the MMU 15 at a timing of a context switch or the like.

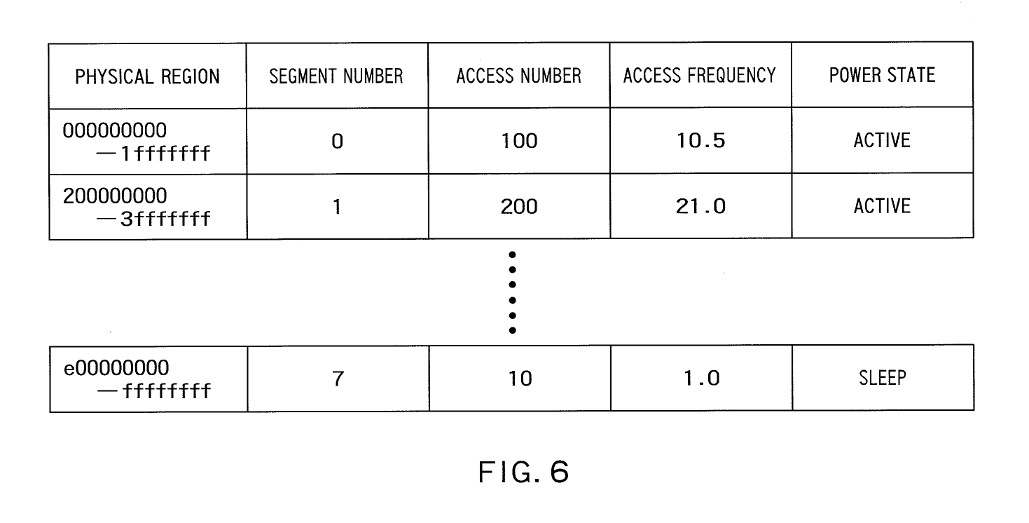

When the physical address is obtained, the segment information management table shown in FIG. 6 is referred to search for the entry corresponding to the physical address. For example, if the physical address efffffff is obtained from the MMU 15, a table in FIG. 6 is referred and it is found that this belongs to the segment 7 and the segment 7 is in the sleep state. In the case of the sleep state, an instruction to change the segment into the active state is transmitted to the memory module 101, and then, an instruction to access (write or read) is transmitted to the memory module 101, and thereafter, an instruction to change the segment into the sleep state is transmitted to the memory module 101.

The access number in the table of FIG. 6 has a value of Sᵢ( ) described above and is incremented by one every access. For example, if certain data is written into the memory H times, the access number is added by the value H at this time. The increment of the access number may be carried out by the MMU 15, CPU core 12, or other means.

Moreover, the access frequency stores Fᵢ( ) described above therein. The OS calculates the access frequency with a timer interrupt at a time interval T using Math. 2, and further the access number in the table of FIG. 6 is cleared to zero. In addition, in a case of a segment having the access frequency lower than a predefined power state determination threshold, if the segment is in the active state, an instruction to change the segment into the sleep state is issued to the memory module 101. In a case of a segment having the access frequency equal to or more than the predefined power state determination threshold, if the segment is in the sleep state, an instruction to change the segment into active state is issued to the memory module. In a case of a segment with no change in the power state (sleep or active), an instruction does not needed to be issued.

In this way, the segment small in the access frequency is set to the sleep state to allow the power consumption of the memory to be reduced. Additionally, since the access to the sleep segments necessary to be carried out after changing the segment into the active state, the access delay is increased. However, the segment having small access frequency is set to the sleep state, which can decrease an effect on a processing speed of the computing device due to the increase in the access delay.

Next, a case is considered where the computing device is started up from a state of S5 in ACPI. The state of S5 in ACPI is a state transited by a shut down operation which is the term in the Windows, and an execution state until that time is not saved. In the case of starting up from S5, as a default in the segment information management table in FIG. 6, the access number and access frequency are zero. Then, it is preferable that in starting up from S5, the power state of the all segments are active and the power state is set on the basis of the access frequency at a predefined timing after the starting up (e.g., a timing when a certain period of time lapses after the starting up is completed). This can prevent decrease of the processing performance at the starting up which is accompanied by relatively many memory accesses.

### (A Variation for Changing the Power State of the Segment)

The explanation is given as an example above of a case where the CPU core issues an instruction to change the power state of the segment to the memory module. But, this instruction may be issued by the MMU 15. Moreover, it is possible that the segment information management table in FIG. 6 is held by the memory module 101 to calculate the access number and access frequency and change the power state of the segment in the memory module 101.

### (Allocation and Deallocation of Memory)

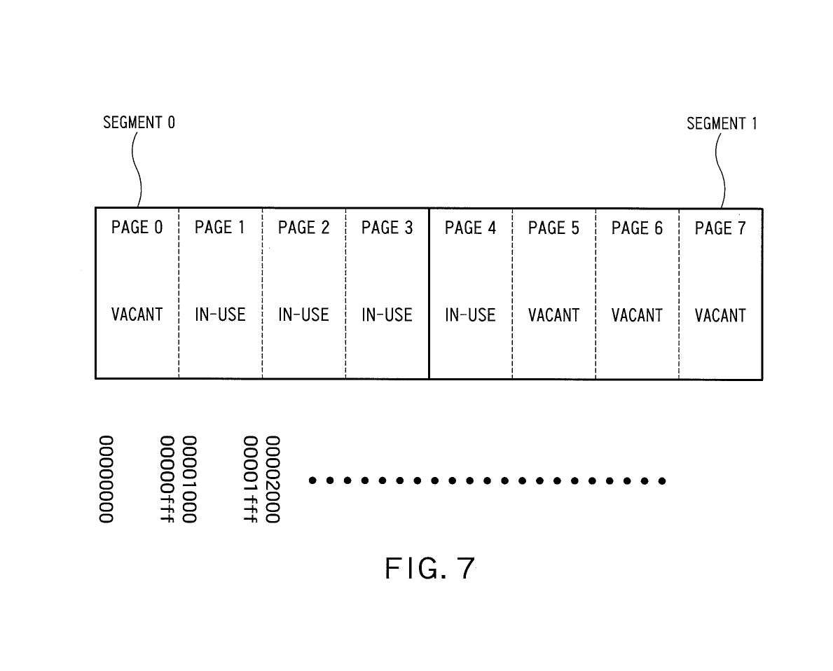

In a case where the process or OS requires the memory, the OS allocates the physical page, decides the corresponding logical address, and writes it into the address translation table. FIG. 7 is a diagram simulatively illustrating a usage state of a physical memory.

One segment has four physical pages, a page 0 is a region of an address from 00000000 to 00000fff, a page 1 is a region of an address from 000001000 to 00002fff (page size is 4 KB). Pages 1, 2, 3, and 4 are already allocated with the memory and being used and the rest is space (unused).

In a case where the OS needs to newly allocate the memory, the smallest address of vacant pages (i.e., available pages) thereof is allocated. By doing so, the vacant pages can be collected to a region having a large address to increase chances of setting the segment having the large address to sleep. Then, correspondence between the logical address and the physical address is registered in the address translation table

When the memory is deallocated, the relevant region in the address translation table is deleted (or, an entry attribute value of the relevant region is changed into an unused state).

### (Configuration of Memory Module)

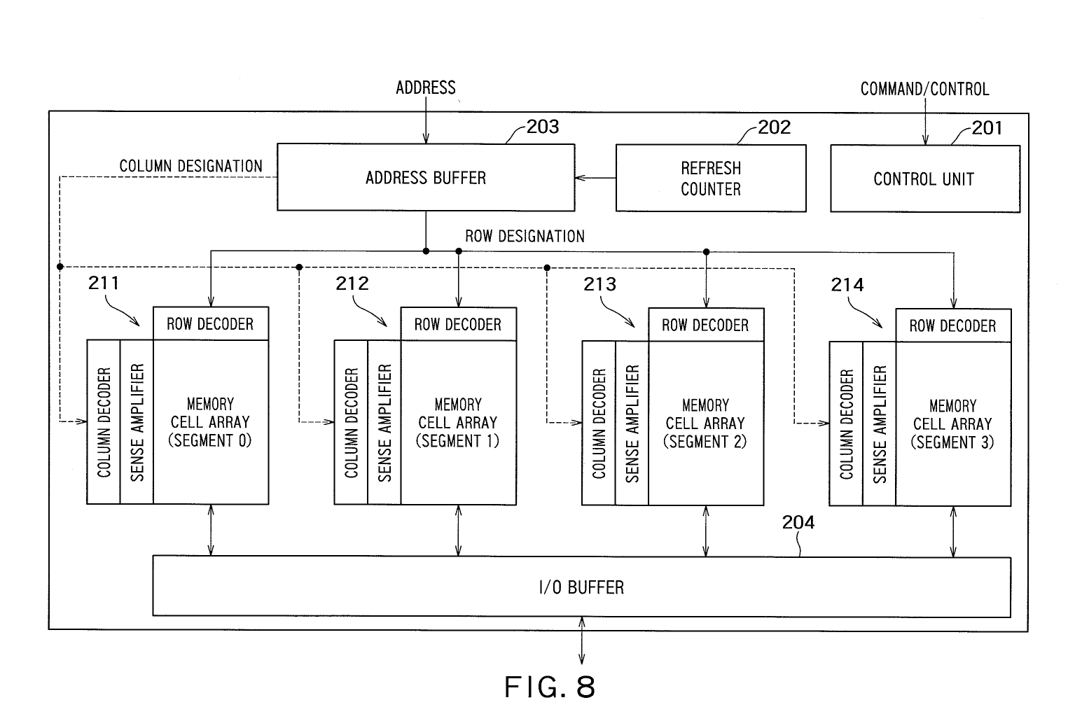

FIG. 8 is a configuration diagram of the memory module 101. The exemplary configuration shown in FIG. 8 is a four-segment configuration. The memory module includes a control unit 201, refresh counter 202, address buffer 203, I/O buffer 204, four memory cell array units 211, 212, 213, and 214. Each memory cell array unit includes a memory cell array, row decoder, column decoder, and sense amplifier.

The control unit 201 receives from the outside a command or control instruction and controls the inside of the memory module in accordance therewith. Examples of control include changing the power state with the segment being designated.

The refresh counter 202, which is required in the case of the DRAM, instructs a refresh target cell and a timing for performing the refresh operation so as not to lose a memory-holding content.

The address buffer 203 receives from the outside the physical address to be divided into a column address and a row address, which are transmitted to the column decoder and the row decoder, respectively. At this time, the address buffer 203 preferably derives from the received address a corresponding segment and transmits the column address and the row address only to the derived segment. The column decoder and the row decoder respectively having received the column address and the row address each read a value of the memory cell designated by the address (in the case of read command) to transmit to the I/O buffer 204.

Each sense amplifier carries out signal amplification when reading the information held in the memory cell.

Each memory cell array, which is constituted by a plurality of memory cells, carries out information holding.

The I/O buffer 204 temporarily accumulates data to be transmitted and received to and from the memory cell array.

Here, assuming that a signal line for transmitting the column address is the shortest between the address buffer 203 and the segment 0, and the longest between the address buffer 203 and the segment 3. If the power consumption driving an address line is larger as the address line is longer, the segment with larger power consumption is preferably set to the sleep state as much as possible. For example, in view of the above described segment order, a cell array with larger power consumption is preferably set to larger segment order.

As shown in FIG. 2, if a plurality of memory chips 102 constitute one memory module, for example, the cell array in the memory chip closer to the right end in FIG. 2 is assigned with larger segment order such that the access to the cell array of large access delay can be reduced.

Further, even in a case where the number of the sleep segments is the same in the memory module, the power consumption reduction effect may be probably high if the sleep segments are concentrated in one chip rather than that the sleep segments are distributed between the chips. For example, if all the segments in one memory chip are set to sleep, the power consumption reduction effect is high. In this case, a continuous segment order is preferably used in the memory chip and between the memory chips. For example, given a memory module mounted with four memory chips, it is preferable that the segment 0 and segment 1 are arranged in the memory chip 0, the segment 2 and segment 3 are arranged in the memory chip 1, the segment 4 and the segment 5 are arranged in the memory chip 2, and the segment 6 and the segment 7 are arranged in the memory chip 3.

Further, if the computing device includes a plurality of memory modules, even in a case where the number of the sleep segments is the same in the computing device, the power consumption reduction effect may be probably high if the sleep segments are concentrated in one memory module rather than that the sleep segments are distributed between the memory modules. For example, if all the segments in one memory module are set to sleep, the power consumption reduction effect is high. In this case, a continuous segment order is preferably used in the memory module and between the memory modules. For example, if two memory modules are included, it is preferable that the segment 0 and the segment 1 are arranged in the memory module 0, and the segment 2 and the segment 3 are arranged in the memory module 1.

Moreover, assuming that a plurality of memory modules is included in the computing device, and a certain memory module (or a semiconductor having a memory function) is present in the same LSI package as the CPU, and another memory module is implemented in another package. At this time, accesses to the memory modules in the same package are expected to be attained with low power consumption and low access delay. For this reason, the memory modules in the same package further compared with others are preferably active state. That is, the segment order is preferably set smaller.

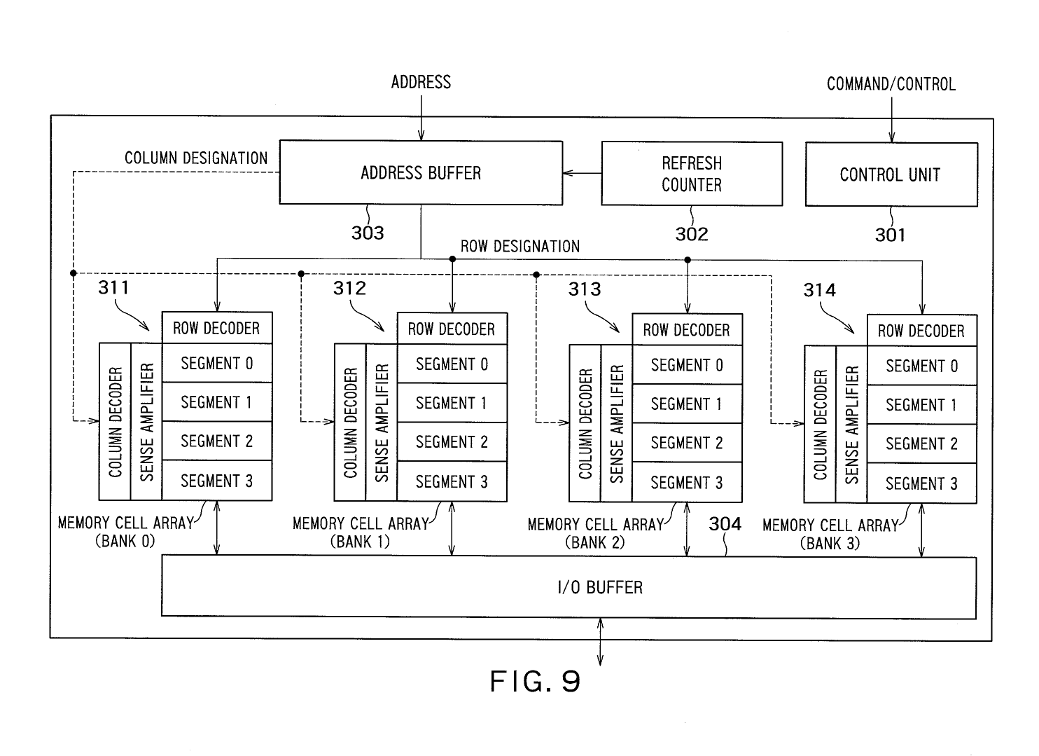

FIG. 9 shows another exemplary configuration of the memory module.

FIG. 9 shows a four-bank configuration in which each of banks (memory cell arrays) 311, 312, 313, and 314 is divided into the segments. The CPU preferably makes the physical address correspond to the memory address as below. Here, the column address side is MSB (most significant bit) rather than the row address side. A transfer unit indicates the number of bits of data which is read and written one time. A channel indicates a memory channel number. The bank indicates a bank number. An identical channel DIMM number indicates a number for identifying respective DIMMs connected with the identical channel.

| | | | | | |
|---|---|---|---|---|---|
| column | Identical | Bank | Row address | Channel | Transfer |
| address | channel | | | | unit |
| | DIMM | | | | |
| | number | | | | |

By doing so, the bank is switched to access the memory with respect to the same row of the memory cell array such that if particularly the transfer unit is large, the memory access can be increased in speed thereof. In addition, as shown in FIG. 4, the physical addresses correspond to those of a continuous region in the segment such that even if the transfer unit is large, an effect is exerted that accesses across a plurality of segments unlikely occur. This effect can be exerted even in the memory module configuration in FIG. 8 by setting the MSB to the column address side rather than the row address.

### (Operation to System Cache Data)

When the process operating on the OS declares referring of a certain file by, for example, calling a fopen( ) system call, the OS reads a file corresponding to a filename (e.g., “/etc/appl.cfg”) given by an argument of the system call from the hard disk, and writes data thereof into the memory. Then, the physical address of the memory is made to correspond to the logical address in the process (refer to FIG. 2). When the process calls, for example, a fclose( ) system call to declare end of referring to a file given by an argument thereof, the correspondence between the logical address in the process and the physical address of the file data is deleted. In a dynamic library such as UNIX lib or Windows DLL, the process does not explicitly declare referring of file, but the OS can know a library required in executing the process. For this reason, the OS arranges files of the library required in executing the process on the memory without the explicit declaration of referring of file.

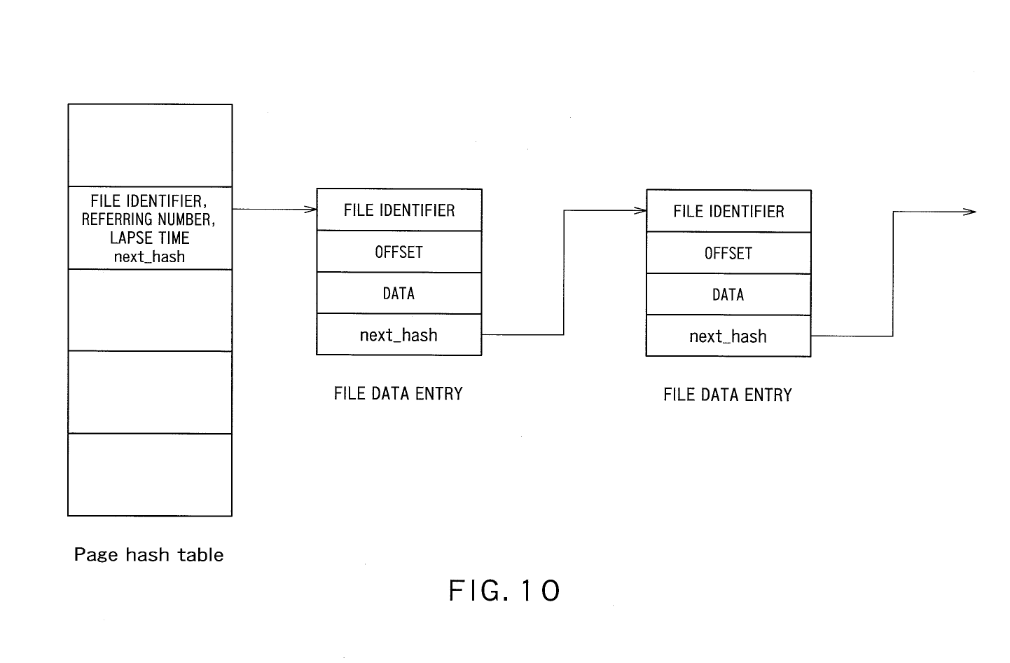

FIG. 10 shows a management structure of the system cache data in the OS. A page hash table is searched on the basis of a file identifier corresponding to a filename to obtain a list concerning the relevant system cache. Here, “file identifier” is UNIX i node, for example.

Each entry of the page has table includes information of file identifier, referring number, lapse time, and next_hash. Here, “referring number” is the number of processes referring to the file. “Lapse time” is a lapse time from when the referring number becomes zero from that larger than zero. “Next_hash” is a pointer to a file data entry in the list concerning the system cache.

In FIG. 10, the list concerning the system cache is formed in a single linked list corresponding to the file identifier. Each entry of this single linked list (file data entry) has values of fields of (file identifier, offset, data, and next_hash). “Offset” represents a relative position of data that this entry indicates in the file corresponding to the file identifier, as what number bit from the top of the file. “Data” is the physical memory addresses where the file data is stored. “Next_hash” is a pointer pointing the next entry. The file data pointed by one file data entry corresponds to a page of data, for example.

When the process declares referring of a file, the OS searches the page hash table from the file identifier thereof, and if an entry exists, the physical addresses of data of the list corresponding to the file identifier are assigned into a virtual space for the process. This assignment is carried out using the address translation table for the process (refer to FIG. 5).

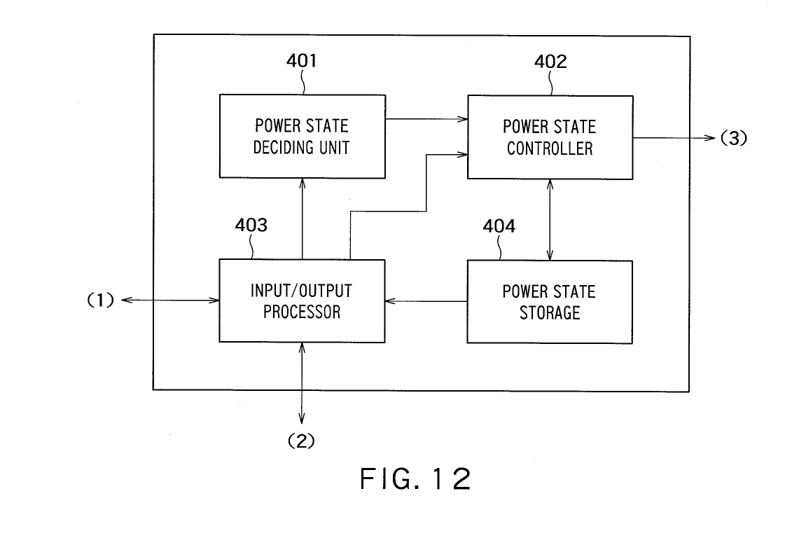

FIG. 12 is a block diagram of a processing unit concerning memory power control in the computing device according to the embodiment. This processing unit includes a power state deciding unit 401, power state controller 402, input/output processor 403, and power state storage 404. A function of each block is achieved by executing a program including program instructions describing execution of these functions, hardware or a combination thereof. A part of these functions may be provided to hardware other than the CPU core 12. The relevant other hardware may be implemented in the memory module or memory chip. The above program may be stored in a computer readable storage media to be read out from the storage media and executed.

As shown in FIG. 12, the input/output processor (typically, CPU), when receiving the memory access request from the outside (typically, from the OS) ((1)), transmits the address included therein to the power state deciding unit 401 and acquires the power state of the segment including the address from the power state storage 404. If the power state is the sleep state, the input/output processor request the power state controller 402 to set the segment to the active state, and then, reads or writes the data in accordance with the memory access request ((2)). If the power state is sleep sate, the input/output processor requests the power state controller 402 to return the segment to the sleep state.

Here, if the memory access request is the read request, the read request includes the address information. Response from the memory includes data information held at the address designated in the memory. In addition, if the memory access request is the write request, the write request includes the address information and data information to be written. Response from the memory includes an event for sending writing completion.

The power state deciding unit 401, when receiving the address from the input/output processor 403, increments the access number of the segment to which this address belongs. The access frequency is calculated at a time interval T on the basis of the access number, and decides the power state of each segment (sleep or active) on the basis of the derived access frequency. The power state deciding unit 401 transmits the decided power state of each segment to the power state controller 402.

The power state controller 402 receives from the power state deciding unit 401 the power state of the segment, which is compared with the current power state held in the power state storage 404. If change is needed, the power state is changed ((3)) and a new power state is set to the power state storage 404.

The power state storage 404 stores the power state of each segment.

In the configuration shown in FIG. 12, the segment information management table in FIG. 6 is considered to be shared and held between the power state storage 404 and the power state deciding unit 401.

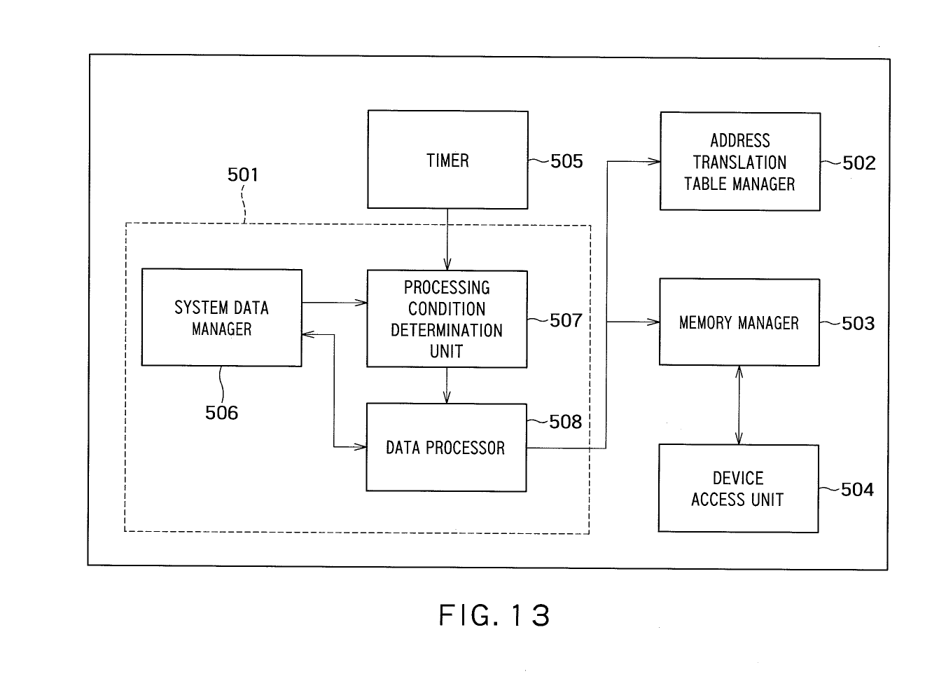

FIG. 13 is a block diagram of a processing unit concerning memory data management control in the computing device according to the embodiment. This processing unit includes a system data processor 501, address translation table manager 502, memory manager 503, device access unit 504, and timer 505.

The address translation table manager 502 manages the address translation table shown in FIG. 5. In other words, a correspondence relation between the physical address and the logical address of each process is maintained and changed.

The memory manager 503 carries out translation between the physical address and the logical address on the basis of the address translation table. The logical address is used as input and the physical address corresponding thereto is output.

The memory manager 503 and the address translation table manager 502 include the function of the MMU 15 and the function of the memory controller shown in FIG. 1 to also perform the read/write processing of data to the main memory. The memory manager 503 may be incorporated with the configuration shown in FIG. 12.

The device access unit 504 performs the read/write processing of data to an external hard disk under the control by the memory manager 503.

The timer 505 transmits an event to the system data processor 501 every certain period of time.

The system data processor 501 includes a system data manager 506, processing condition determination unit 507, and data processor 508.

The system data manager 506 maintains and changes the file data management structure shown in FIG. 10.

The processing condition determination unit 507 from the system data manager 506 determines, with respect to the file data of referring number zero, whether the data is on the hot memory region or on the cold memory region. The data on the hot memory region is determined whether to be moved to the cold memory region on the basis of the lapse time from when the referring number becomes zero and the threshold T_hot, and a determination result is notified to the data processor 508. The data on the cold memory region is determined whether to be deleted on the basis of the lapse time from when the referring number becomes zero and the threshold T_cold, and a determination result is notified to the data processor 508. If the dirty data or the like is written back to the hard disk, the data processor 508 may be notified of that.

The data processor 508 performs the processing in accordance with the notification from the processing condition determination unit 507. If the data on the hot memory region is moved to the cold memory region, the memory manager 503 is instructed to move the data. The memory manager 503 moves the data in accordance with the instruction, and rewrites the address translation table. The data processor 508 notifies a data processing result to the system data manager 506 and the system data manager 506 updates the file data management structure in FIG. 10 so as to match an actual memory-holding state.

If the data on the cold memory region is deleted, the data processor 508 instructs the memory manager 503 to delete the data. The memory manager 503 deletes the date in accordance with the instruction and rewrites the address translation table. In addition, the data processor 508 notifies the data processing result to the system data manager 506 and the system data manager 506 updates file data management structure in FIG. 10 so as to match an actual memory-holding state. If the data to be deleted is written back to the hard disk, the memory manager 503 is instructed to write back the data from the memory manager 503 via the device access unit 504.

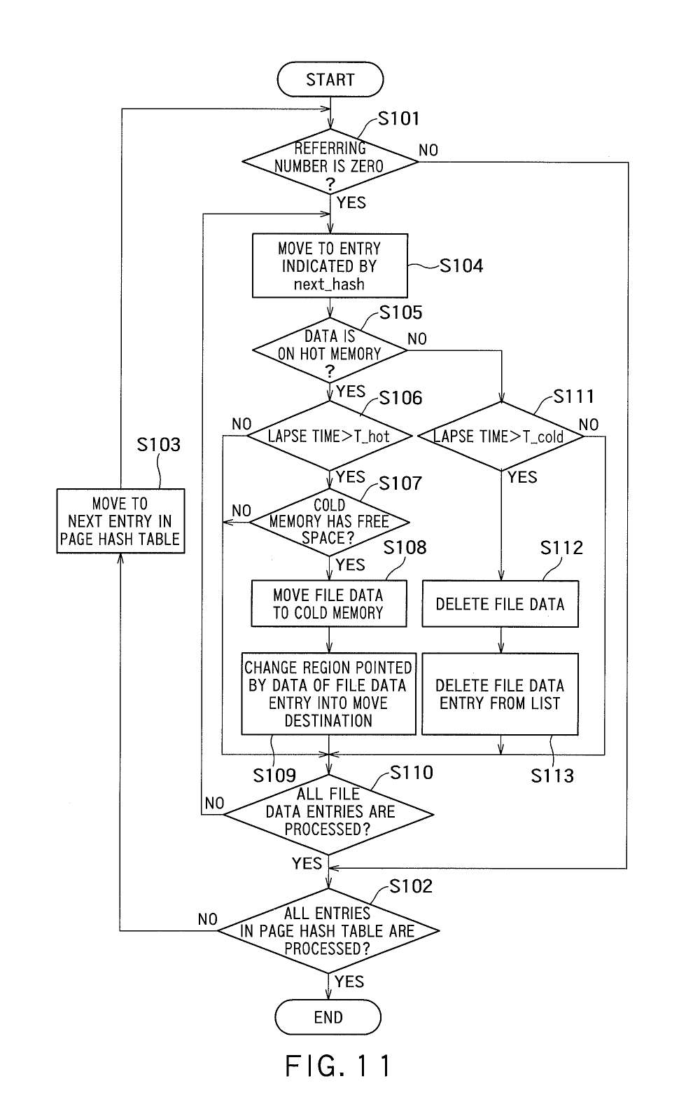

FIG. 11 shows an operation flowchart concerning the system cache processing as the operation of the processing unit shown in FIG. 13. This flow processing is performed to each entry of the page hash table (that is, each file on the memory). Note that, as described above, each entry of the page hash table in FIG. 10 is a list header of the list of the information concerning each file on the memory. The operation according to the flowchart in FIG. 11 is performed at a constant time interval to move the system cache.

An event is periodically output from the timer 505 to the system data processor 501. When the system data processor 501 detects an event, the processing condition determination unit 507 identifies one entry (file) in the page hash table and checks whether or not the referring number of the entry is zero (S101). If the referring number is not zero (that is, one or more), whether or not all entries are processed is checked (S102). If unprocessed entry exists in the page hash table, the next entry is subjected (S103). If all the entries are processed, this flow operation ends.

If the referring number is zero, the processing condition determination unit 507 moves to the file data entry of that file (S104), and checks which the hot memory region or the cold memory region the file data exists on (S105).

If the file data exists on the hot memory region, the processing condition determination unit 507 determines whether or not the lapse time from when the referring number becomes zero exceeds T_hot (S106). In other words, it is determined whether or not the state of referring number zero is continued for a first time period after the referring number becomes zero. If the lapse time exceeds T_hot, (YES at S106), in a case where the cold memory region has a free space (YES at S107), that file data is determined to be moved to the cold memory region and the data processor 508 is notified of the determination. The data processor 508 moves the data via the memory manager 503 to update the address translation table (S108). In addition, the system data manager 506 changes a region pointed by a data field of the entry of the file data into a move destination (physical address in the cold memory region) (S109). In this way, the data on the physical memory is moved (an in-use flag for the above physical page management data is also operated) to change such that a position pointed by the data field of the file data entry is the physical page of the move destination.

If the lapse time from when the referring number becomes zero is equal to or less than T_hot (NO at S106) or, the cold memory region has no free space (NO at S107), the processing condition determination unit 507 determines that the file data is not moved.

The processing condition determination unit 507 checks whether or not all the file data entries are processed (S110), and if an unprocessed entry exists, the next entry pointed by the next_hash in the current entry is to be subjected to the processing (S104).

On the other hand, if the file data exists on the cold memory region, the processing condition determination unit 507 determines whether or not the lapse time from when the referring number becomes zero exceeds T_cold (S111). In other words, it is determined whether or not the state of referring number zero is continued for a second time period after the referring number becomes zero. Note that cases may be considered where the data is moved to the cold memory region after the referring number becomes zero on the hot memory region, and the referring number becomes zero when the data exists on the cold memory region which originally exists on the cold memory region. In the former case, a time point when the referring number becomes zero on the hot memory region is a starting point of the lapse time. In the latter case, a time point when the referring number becomes zero on the cold memory region is a starting point of the lapse time. If the lapse time exceeds T_cold, the data processor 508 is instructed to delete the file data, and corresponding thereto, the data processor 508 deletes the data via the memory manager 503 (S112), and the system data manager 506 deletes the file data entry from the list (S113). Deleting the file data means that an in-use flag (flag indicating presence or absence of the data) for the physical page management data (not shown) is cleared. Deleting the file data entry from the list means that the file data entry of the page hash table is cleared. When deleting the file data entry, the next_hash value of the former stage entry of the file data entry to be deleted (entry of the page hash table or the file data entry) is updated so as to point the file identifier of the latter stage file data entry of the file data entry to be deleted. The processing condition determination unit 507 checks whether or not all the file data entries are processed (S110), and if an unprocessed entry exists, the next entry pointed by the next_hash in the current entry is to be subjected to the processing (S104).

The operation according to the flowchart in FIG. 11 is performed at a constant time interval such that the system cache is moved. In a case where a free space in the memory is small, the time interval for the operation may be lowered. Additionally, the value of either one or both T_hot and T_cold may be applied with a different value depending on whether the file data is dirty (data value is changed by the process) or clean (data value is not changed). In the case of dirty data, a smaller value is preferably used compared with the case of clean data. This makes it possible to give priority to the dirty data which is necessary to be written back to the hard disk to deallocate the memory. Therefore, even if the memory is short, such a phenomenon can be prevented that the time required for deallocating the memory is extended due to the time required for writing back the dirty data, as a result of which the time required for assigning the memory to new data is extended.

### (Remarks)

According to the embodiment, the memory access frequency for each segment is calculated to control the power state of the segment on the basis of the access frequency. In the embodiment, various modifications may be made and can be implemented in a computing device architecture not having the MMU, for example.

Further, in the embodiment, the OS calculates the access frequency, on the basis of which a change request of the power state is transmitted to the memory module. As another configuration, it is possible that the memory module measures the access number and calculates the access frequency, and the memory module itself changes the power state of the segment. In this case, the memory module, if memory access to the sleep segment is detected, changes the segment into the active state, and transits the segment to the sleep state after processing the access.

Further, in the embodiment, the OS calculates the memory access frequency, on the basis of which the change request of the power state is transmitted to the memory module. As another configuration, this may be carried out by a program executed in a user space such as the daemon process. Alternatively, this can be also implemented not in the CPU processing of software but in a processing by another hardware.

In the embodiment, the explanation is given assuming that the memory has two power states of the active state and the sleep state, but three or more power states can be used. For example, a readable and writable state is divided into a first active state and a second active state. The first active state is larger than the second active state in the power consumption, but smaller in the access delay. This can be attained by making either one or both of a clock and a refresh rate inside the memory larger in the first active state than the second active state, for example. In a case where the access frequency Fᵢ( ) of the segment in the first active state is smaller a certain threshold, the second active state is set. Of course, if the access frequency is further small (the access frequency is smaller than another threshold which is smaller than the certain threshold), the sleep state is preferably set.

Moreover, a state where the read and write access to the memory is impossible can be divided into plural states. For example, the state is divided into a first sleep state and a second sleep state. It can be defined that the first sleep state is larger than the second sleep state in the power consumption but smaller in a delay for setting the active state. This can be implemented due to a size of a circuit part that is stopped feeding power, in an access circuit. For example, it can be implemented by setting a state where circuits other than PLL in the access circuit are stopped feeding the power to the first sleep state and setting a state where most circuits including the PLL in the access circuit are stopped feeding the power to the second sleep state. In a case where the access frequency Fᵢ( ) of the segment in the second sleep state is larger than a certain threshold, the first sleep state is set. Of course, if the access frequency is further large (the access frequency is larger than another threshold which is larger than the relevant certain threshold), the active state is preferably set.

In the embodiment, read and write are not distinguished from each other to calculate the access frequency. However, a read access frequency and a write access frequency are calculated, on the basis of which the power state can be also set. For example, the circuit is configured such that if the read access frequency is smaller than a threshold, the access delay is set larger with respect to read as the power state of the segment so that the memory power consumption becomes small. Further, if the write access frequency is smaller than a threshold, the access delay is set larger with respect to write as the power state of the segment so that the memory power consumption becomes small. In these cases, the power states for read and write are preferably handled independently and simultaneously.

The present invention is applicable not only to a volatile memory such as a DRAM but also to a nonvolatile memory such as a MRAM. In this case, the power consumption in the sleep state can be further reduced, which is more preferable. Moreover, the present invention is applicable to a computing device which uses plural kinds of memories such as the DRAM and MRAM.

In the embodiment, the system cache data is moved between the hot memory and the cold memory, but the embodiment is applicable to a case where other data, that is, file data being referred, data in a heap area of the process, data region, or text region, and the like is moved depending on the access frequency thereof and the like.

If the system cache data on the memory (that is, data of the referring number zero) is held on the cold memory, the system cache data is preferably moved from the cold memory to the hot memory at a time point when the data is referred or a time point when the first access occurs. In the case of moving to the hot memory at the time point when the first access occurs, only the accessed page is preferably moved to the hot memory, but for the purpose of a simple processing, all data on the cold memory in the accessed file may be moved to the hot memory.

In a case where the system cache data is data not managing the referring number, not the lapse time from when the referring number becomes zero but a lapse time from when the last access may be used to carry out the operation in the embodiment. Further, T_hot and T_cold may have a different value depending on a type of the system cache data, for example, page cache or buffer cache.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A computing device managing a first memory region and a second memory region, a power consumption to hold data stored in the second memory region being smaller than that of the first memory region, comprising:
a data manager managing a referring number which is a number of processes referring to first data existing in either one of the first memory region or the second memory region; and
a data processor moving the first data to the second memory region when the first data exists in the first memory region and the referring number to the first data satisfies a first condition.

2. The computing device according to claim 1 wherein
a power consumption or an access time required for accessing the first memory region is smaller than a power consumption or an access time required for accessing the second memory region.

3. The computing device according to claim 1 wherein
the first condition is that the referring number falls from a value larger than a threshold down to a value equal to or less than the threshold.

4. The computing device according to claim 3 wherein
the first condition is that the referring number falls from a value larger than a threshold down to a value equal to or less than the threshold, and thereafter a state of being equal to or less than the threshold is continued for a first time period.

5. The computing device according to claim 4 wherein
in a case where the first data is updated after being written into the first memory region, the data processor sets a value of the first time period smaller.

6. The computing device according to claim 4 wherein
the smaller a free space in the first memory region is, the smaller the data processor sets the value of the first time period.

7. The computing device according to claim 3 wherein
the threshold is zero.

8. The computing device according to claim 1 wherein
the data processor moves the first data to a storage device when the first data exists in the second memory region and the referring number to the first data satisfies a second condition.

9. The computing device according to claim 8 wherein
in a case where the first data is not updated after being written into the second memory region, the data processor deletes the first data without moving the first data to the storage device.

10. The computing device according to claim 8 wherein
the second condition is that a state of the referring number zero is continued for a second time period.

11. The computing device according to claim 10 wherein
in a case where the first data is updated after being written into the second memory region, the data processor sets a value of the second time period smaller.

12. The computing device according to claim 10 wherein
the smaller a free space in the second memory region is, the smaller the data processor sets the value of the second time period.

13. A method of managing a first memory region and a second memory region, a power consumption to hold data stored in the second memory region being smaller than that of the first memory region, comprising:
managing a referring number which is a number of processes referring to first data existing in either one of the first memory region or the second memory region; and
moving the first data to the second memory region when the first data exists in the first memory region and the referring number to the first data satisfies a first condition.

14. A non-transitory computer readable medium having instructions stored therein which causes, when executed by a processor, the processor to execute processing of steps comprising:
managing a referring number which is a number of processes referring to first data existing in either one of a first memory region or a second memory region, a power consumption to hold data stored in the second memory region being smaller than that of the first memory region; and
moving the first data to the second memory region when the first data exists in the first memory region and the referring number to the first data satisfies a first condition.
